(19) United States
(12) Patent Application Publication
(10) Pub. No.: US 2013/0255448 A1
(43) Pub. Date: Oct. 3, 2013

(54) PNEUMATIC DRIVEN RATCHET WRENCH CAPABLE OF PREVENTING MIS-SWITCHING OF ROTATIONAL DIRECTIONS OF A SPINDLE

(71) Applicant: BASSO INDUSTRY CORP., Taichung (TW)

(72) Inventor: Chun-Chi LAI, Taichung (TW)

(73) Assignee: BASSO INDUSTRY CORP., Taichung (TW)

(21) Appl. No.: 13/838,608

(22) Filed: Mar. 15, 2013

(30) Foreign Application Priority Data
Mar. 28, 2012 (TW) 101110814

(51) Int. Cl. B25B 21/00

(52) U.S. Cl. CPC B25B 21/004
USPC 81/57.44

(57) ABSTRACT

A pneumatic driven ratchet wrench comprises: a wrench housing; a spindle-engaging unit including a ratchet wheel; a rotation-driving unit for driving rotation of the spindle; a direction-driving unit; a reverse gear unit driven by the direction-driving unit to engage the ratchet wheel so as to switch rotational directions of the spindle; a first valve unit operable to permit fluid communication between a first fluid passage and one of a chamber and a second fluid passage while preventing fluid communication between the first fluid passage and the other of the chamber and the second fluid passage; and a second valve unit operable to permit fluid communication between the second fluid passage and a selected one of third and fourth fluid passages.

### CROSS-REFERENCE TO RELATED APPLICATION

This application claims priority of Taiwanese Application No. 101110814, filed on Mar. 28, 2012.

### BACKGROUND OF THE INVENTION

1. Field of the Invention

This invention relates to a pneumatic driven ratchet wrench, more particularly to a pneumatic driven ratchet wrench having a spindle and a valve unit capable of preventing mis-switching of rotational directions of the spindle.

2. Description of the Related Art

Referring to FIGS. 1 and 2, U.S. Pat. No. 6,640,669 discloses a conventional pneumatic driven ratchet wrench 1 that includes a wrench housing 11, a spindle 12, two reverse gear arms 14, a yoke 131 engaging the spindle 12, a pawl 132 engageable with the spindle 12 at different engaging positions (not shown) for switching rotational directions of the spindle 12, a reverse gear 133 for driving movement of the pawl 132, two reverse buttons 15 mounted slidably on the wrench housing 11 for driving movement of the reverse gear arms 14, a rotor 16 mounted rotatably in the wrench housing 11 for driving rotation of the spindle 12 through the yoke 131, and a valve unit 17. The wrench housing 11 is formed with a fluid passage 111 and a rotor-driving chamber 161. The valve unit 17 includes a valve stem 171 with a sealing disc 173, and an open-close lever 172 for driving movement of the valve stem 171 for controlling fluid communication between the fluid passage 111 and the rotor-driving chamber 161. To switch the spindle 12 to a desired rotational direction, a corresponding one of the reverse buttons 15 is moved from a first position (see FIG. 2) to a second position (not shown) to drive movement of a corresponding one of the reverse gear arms 14, which, in turn, drives rotation of the reverse gear 133 so as to move the pawl 132 to a desired one of the engaging positions.

The Applicant found that the conventional pneumatic driven ratchet wrench 1 is disadvantageous in that one of the reverse buttons 15 can be accidentally moved from the first position to the second position by a user to cause undesired switching of the rotational directions of the spindle 12 while the spindle 12 is rotating in one of the rotational directions, which can result in damage to the spindle 12, the pawl 132 and the reverse gear 133 and result in a decrease in the service life of the pneumatic driven ratchet wrench 1.

### SUMMARY OF THE INVENTION

Therefore, the object of the present invention is to provide a pneumatic driven ratchet wrench that can overcome the aforesaid drawback associated with the prior art.

According to this invention, there is provided a pneumatic driven ratchet wrench having a spindle and capable of preventing mis-switching of rotational directions of a spindle. The pneumatic driven ratchet wrench comprises: a wrench housing having first and second sections and a middle section disposed between and interconnecting the first and second sections, the first section being formed with a first fluid passage, the middle section being formed with a second fluid passage, a rotor-driving chamber separated from the second fluid passage, and third and fourth fluid passages separated from the rotor-driving chamber; a spindle-engaging unit mounted to the second section and including a ratchet wheel that is adapted to be associated with the spindle for switching rotational directions of the spindle; a rotation-driving unit including a pneumatic rotor that is mounted rotatably in the rotor-driving chamber, that is adapted to be connected to the spindle, and that is adapted to be driven to rotate by a compressed air entering from the first fluid passage into the rotor-driving chamber so as to drive rotation of the spindle; a direction-driving unit mounted in the wrench housing and adapted to be driven to move by the compressed air entering from the first fluid passage through the second fluid passage into a selected one of the third and fourth fluid passages; a reverse gear unit mounted movably in the wrench housing and driven by the direction-driving unit to engage the ratchet wheel so as to switch rotational directions of the spindle; a first valve unit operatively mounted in the wrench housing and operable to permit fluid communication between the first fluid passage and a selected one of the rotor-driving chamber and the second fluid passage while preventing fluid communication between the first fluid passage and the other of the rotor-driving chamber and the second fluid passage; and a second valve unit operatively mounted in the wrench housing for controlling fluid communication between the second fluid passage and a selected one of the third and fourth fluid passages so as to control switching of the rotational directions of the spindle.

### BRIEF DESCRIPTION OF THE DRAWINGS

In drawings which illustrate an embodiment of the invention,

FIG. 1 is a sectional view of a conventional pneumatic driven ratchet wrench;

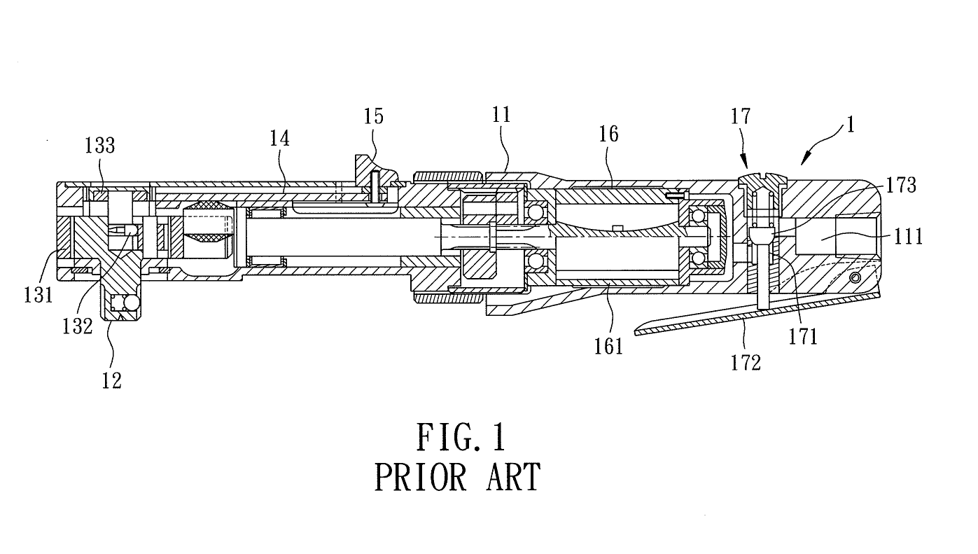

FIG. 2 is a fragmentary schematic view of the conventional pneumatic driven ratchet wrench;

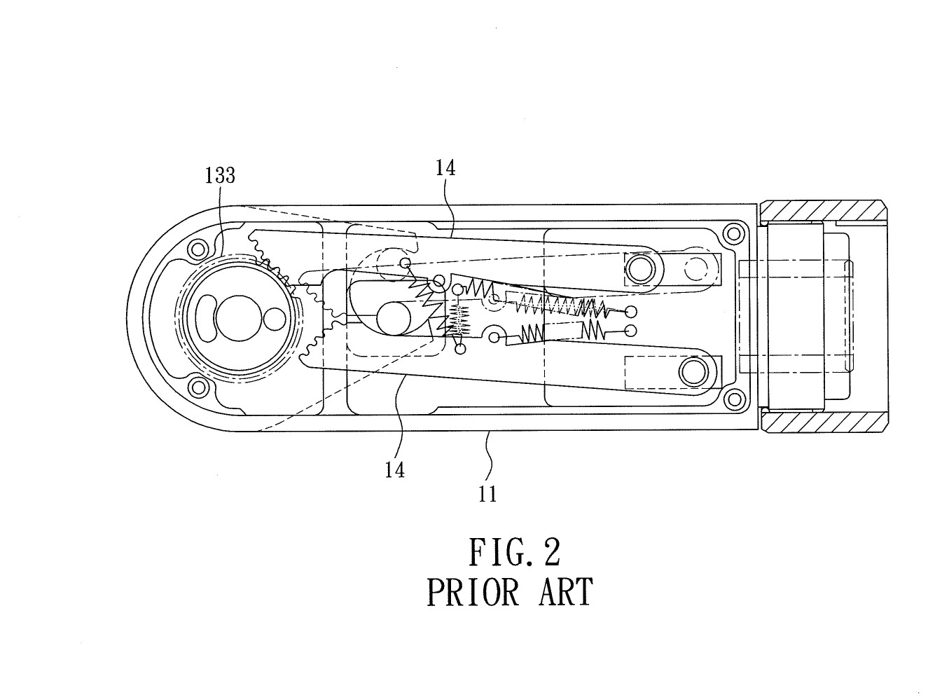

FIG. 3 is a sectional view of the preferred embodiment of a pneumatic driven ratchet wrench according to the present invention;

FIG. 4 is a sectional view taken along lines PV-PV in FIG. 3;

FIG. 5 is a sectional view taken along lines V-V in FIG. 3;

FIG. 6 is a sectional view illustrating a state where a valve stem is moved away from a valve seat of a valve unit of the preferred embodiment so as to permit fluid communication between a second fluid passage and a third fluid passage;

FIG. 7 is a sectional view illustrating a state where one of two reverse gears is moved from a disengaging position to an interengaging position;

FIG. 8 is a sectional view illustrating a state where a valve stem is moved away from a valve seat of a valve unit of the preferred embodiment so as to permit fluid communication between a first fluid passage and a rotor-driving chamber;

FIG. 9 is a fragmentary partly sectional view illustrating a first state of a first valve unit of the preferred embodiment;

FIG. 10 is a fragmentary partly sectional view illustrating a middle state of the first valve unit of the preferred embodiment; and

FIG. 11 is a fragmentary partly sectional view illustrating a second state of the first valve unit of the preferred embodiment.

### DETAILED DESCRIPTION OF THE PREFERRED EMBODIMENT

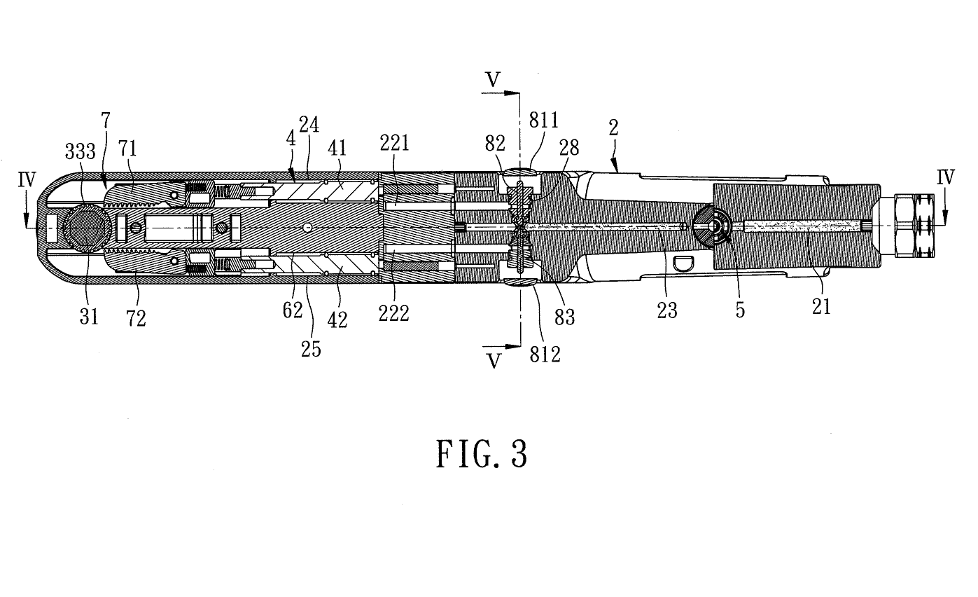

FIGS. 3 to 5 illustrate the preferred embodiment of a pneumatic driven ratchet wrench according to the present invention. The pneumatic driven ratchet wrench includes a wrench housing 2, a spindle 31, a spindle-engaging unit 3, a rotation-driving unit 6, a direction-driving unit 4, a reverse gear unit 7, a first valve unit 5, and a second valve unit 8.

The wrench housing 2 has first and second sections 201, 202 and a middle section 203 disposed between and interconnecting the first and second sections 201, 202. The first section 201 is formed with a first fluid passage 21, and is adapted to be connected to a compressed air supplying source (not shown). The middle section 203 is formed with a second fluid passage 23, a rotor-driving chamber 26 separated from the second fluid passage 23, third and fourth fluid passages 221, 222 separated from the rotor-driving chamber 26, and first and second piston channels 24, 25. Each of the third and fourth fluid passages 221, 222 is disposed between the second fluid passage 23 and a respective one of the first and second piston channels 24, 25, along a length direction of the middle section 203, and is in fluid communication with the respective one of the first and second piston channels 24, 25.

A first switch lever 51 is pivoted to an exterior of the wrench housing 2. A U-shaped second switch lever 81 has first and second pressing ends 811, 812 and a middle pivot portion 813 that is disposed between the first and second pressing ends 811, 812 and that is pivoted to the exterior of the wrench housing 2.

The spindle-engaging unit 3 is mounted to the second section 202 of the wrench housing 2, and includes a yoke 331 engaging the spindle 31 for driving rotation of the spindle 31, a pawl 332 engageable with the spindle 31 at two different engaging positions (not shown) for switching rotational directions of the spindle 31, and a ratchet wheel 333 engaging the pawl 332 for driving movement of the pawl 332 between the engaging positions relative to the spindle 31.

The rotation-driving unit 6 includes a cylindrical pneumatic rotor 61 and a rotation shaft 62. The pneumatic rotor 61 is mounted rotatably in the rotor-driving chamber 26, and is adapted to be driven to rotate by a compressed air entering from the first fluid passage 21 into the rotor-driving chamber 26. The rotation shaft 62 is coupled to the pneumatic rotor 61 so as to co-rotate with the pneumatic rotor 61 relative to the wrench housing 2 about a central axis (X), and is connected to the spindle 31 through the yoke 331 for driving rotation of the spindle 31.

The direction-driving unit 4 includes first and second pistons 41, 42 that are mounted movably in the first and second piston channels 24, 25 in the middle section 203 of the wrench housing 2, respectively. Each of the first and second pistons 41, 42 is driven to move relative to the wrench housing 2 by the compressed air entering from the first fluid passage 21 through the second fluid passage 23 into a respective one of the third and fourth fluid passages 221, 222 and a respective one of the first and second piston channels 24, 25.

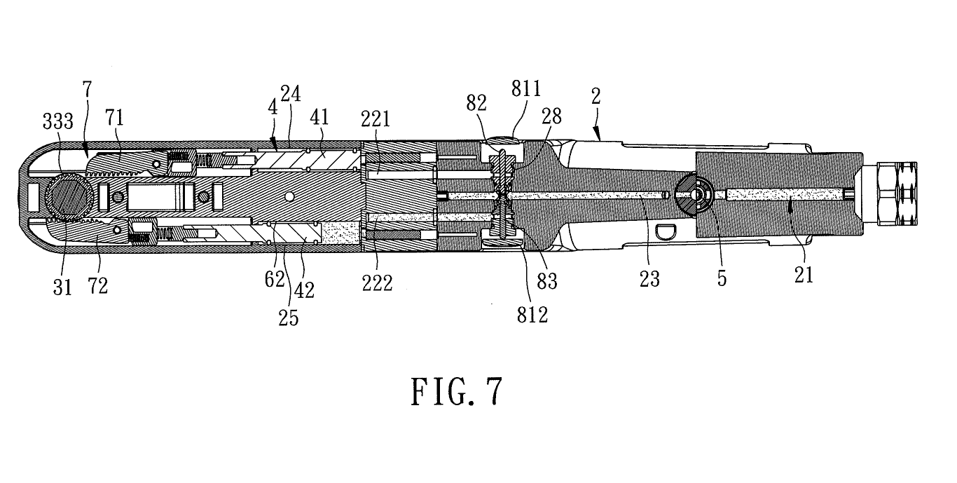

The reverse gear unit 7 includes first and second reverse gears 71, 72 that are mounted movably in the wrench housing 2 and that are connected to and that are driven by the first and second pistons 41, 42, respectively, to move relative to the wrench housing 2 from a disengaging position (see FIG. 3) to an interengaging position (see FIG. 7) to engage the ratchet wheel 333 and to drive rotation of the ratchet wheel 333, which, in turn, drives movement of the pawl 332 for switching rotational directions of the spindle 31.

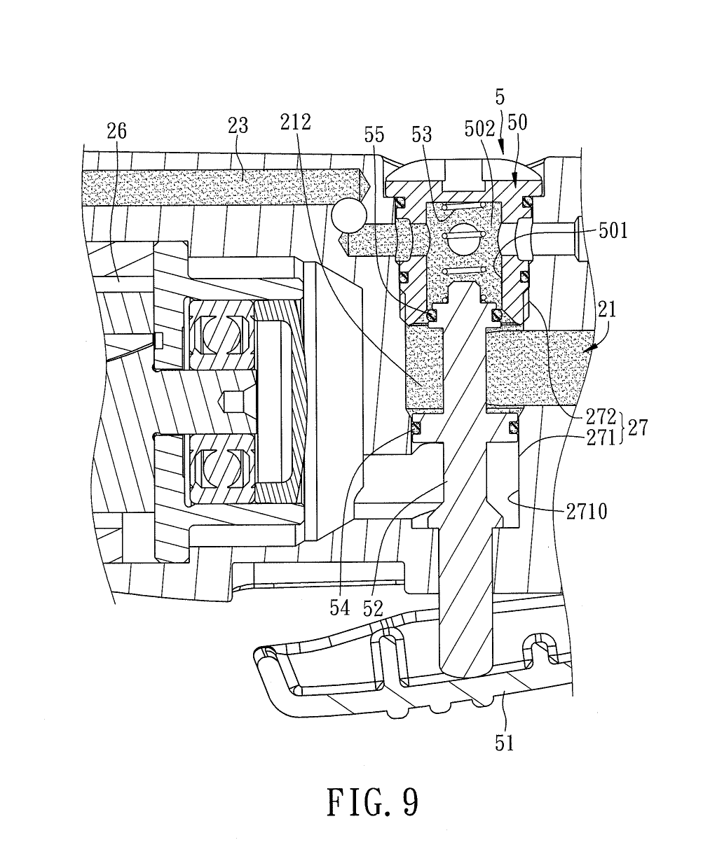

The wrench housing 2 is formed with a first valve-receiving space 27 that receives the first valve unit 5 therein, and a second valve-receiving space 28 that receives the second valve unit 8 therein. The first valve-receiving space 27 has cylindrical first and second sections 271, 272 (see FIG. 9) opposite to each other and extending in a direction perpendicular to the central axis (X). The first fluid passage 21 has an end section 212 extending in a direction parallel to the central axis (X) and disposed between the first and second sections 271, 272 for communicating with a selected one of the first and second sections 271, 272 through operation of the first valve unit 5. The first section 271 of the first valve-receiving space 27 is defined by a section-defining wall 2710, and is in fluid communication with the rotor-driving chamber 26.

The first valve unit 5 is operatively mounted in the wrench housing 2, and is operable to permit fluid communication between the first fluid passage 21 and a selected one of the rotor-driving chamber 26 and the second fluid passage 23 while preventing fluid communication between the first fluid passage 21 and the other of the rotor-driving chamber 26 and the second fluid passage 23.

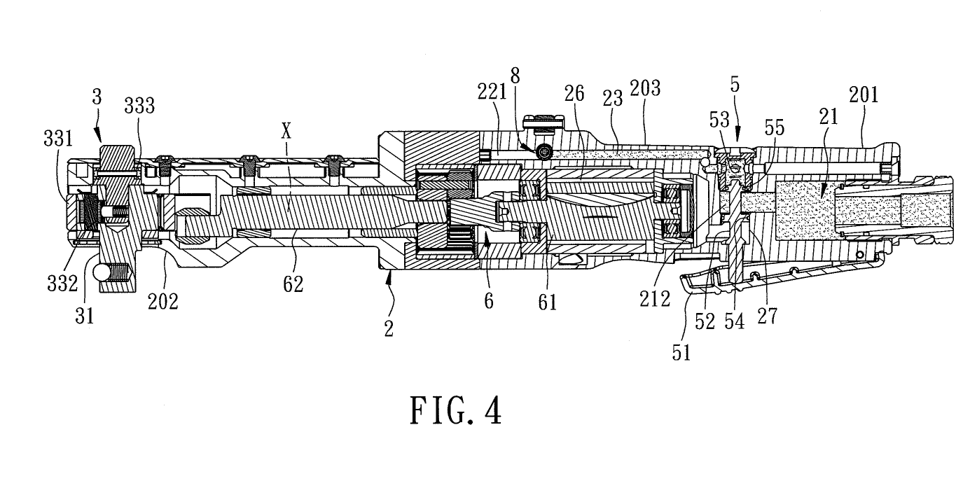

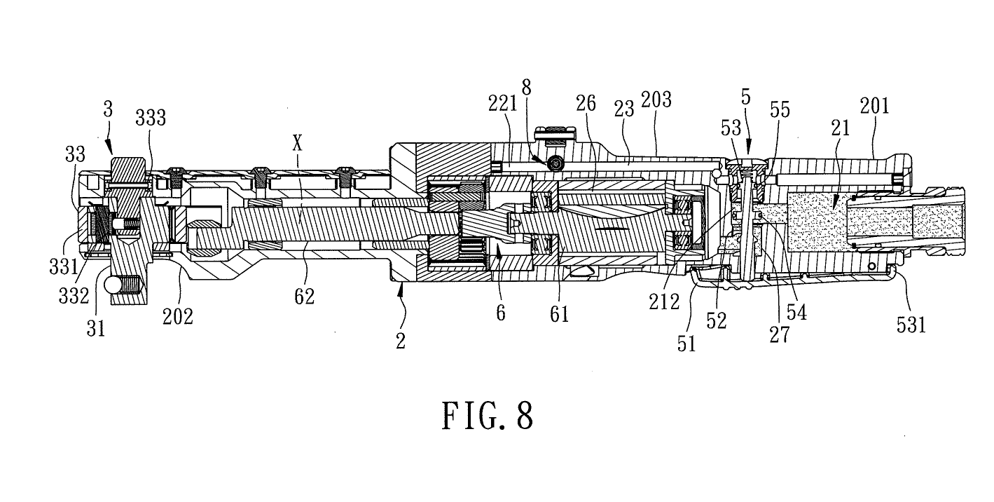

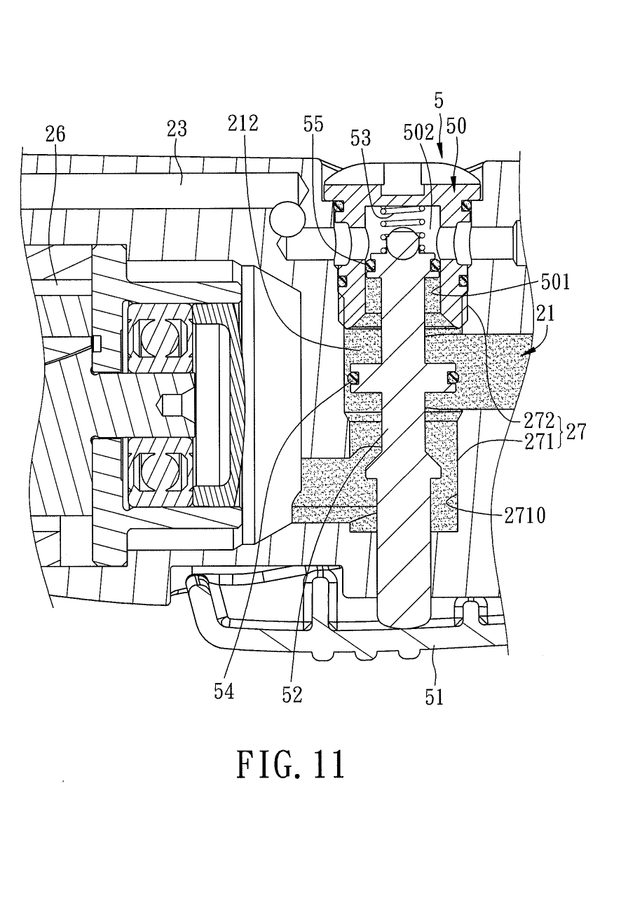

In this embodiment, the first valve unit 5 is operable between a first state (see FIGS. 4 and 9), in which the first valve unit 5 prevents fluid communication between the first fluid passage 21 and the rotor-driving chamber 26 while permitting fluid communication between the first fluid passage 21 and the second fluid passage 23, and a second state (see FIGS. 8 and 11), in which the first valve unit 5 permits fluid communication between the first fluid passage 21 and the rotor-driving chamber 26 while preventing fluid communication between the first fluid passage 21 and the second fluid passage 23, thereby rendering the pneumatic driven ratchet wrench capable of preventing mis-switching of the rotational directions of the spindle 31.

The first valve unit 5 has a cylindrical valve body 50 (see FIG. 9) secured in the second section 272 of the first valve-receiving space 27, a valve stem 52 extending through the first section 271 of the first valve-receiving space 27, the end section 212 of the first fluid passage 21 and the second section 272 of the first valve-receiving space 27, a first urging member 53 abutting against an end of the valve stem 52 and an end of the valve body 50, and first and second sealing elements 54, 55 that are mounted on the valve stem 52 and that are spaced apart from each other. The valve body 50 has an inner wall surface 501 that defines a fluid channel 502 which is in fluid communication with the second fluid passage 23.

The first switch lever 51 is rotatable relative to the wrench housing 2 to drive movement of the valve stem 52 so as to permit disposing of the first valve unit 5 between the first and second states. When the first valve unit 5 is disposed at the first state (i.e., when the first switch lever 51 is not pressed and is disposed at its original position), the first sealing element 54 is disposed in the first section 271 and is in sealing contact with the section-defining wall 2710 while the second sealing element 55 is disposed outwardly of the fluid channel 502 and is disposed in the end section 212 of the first fluid passage 21, thereby preventing fluid communication between the first fluid passage 21 and the rotor-driving chamber 26 via the first section 271 of the first valve-receiving space 27 and permitting fluid communication between the first fluid passage 21 and the second fluid passage 23 via the fluid channel 502. When the first valve unit 5 is disposed at the second state (i.e., the first switch lever 51 is fully pressed by a user), the first sealing element 54 is disposed outwardly of the first section 271 and is dispose in the end section 212 of the first fluid passage 21 while the second sealing element 55 is disposed in the fluid channel 502 and is in sealing contact with the inner wall surface 501, thereby permitting fluid communication between the first fluid passage 21 and the rotor-driving chamber 26 via the first section 271 and preventing fluid communication between the first fluid passage 21 and the second fluid passage 23 via the fluid channel 502. The urging member 53 urges and restores the valve stem 52 and the first switch lever 51 to their original positions to dispose the first valve unit 5 at the first state.

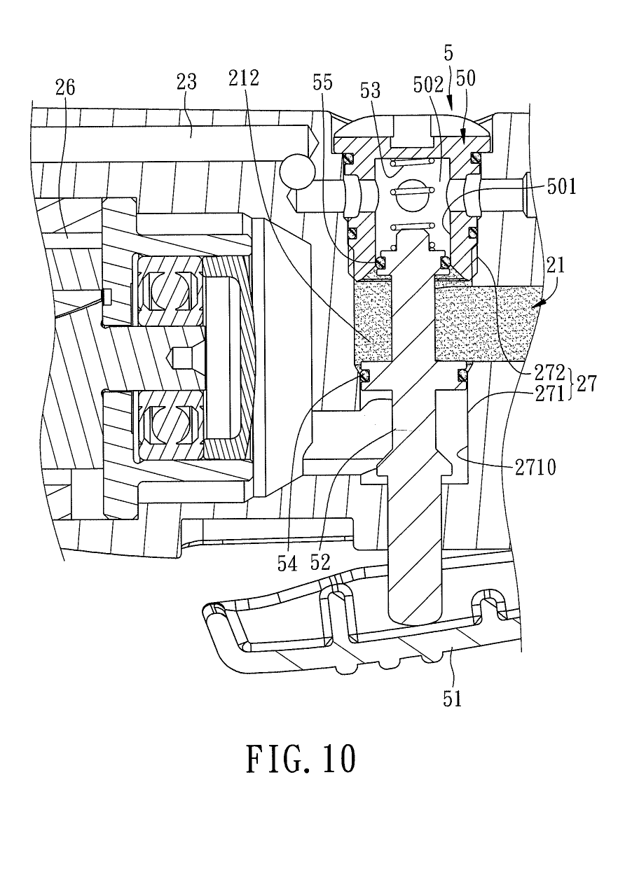

In addition, it is preferably for the first valve unit 5 to be further operable at a middle state (see FIG. 10) between the first and second states such that at the middle state, the second sealing element 55 is disposed in the fluid channel 502 and is in sealing contact with the inner wall surface 501 while the first sealing element 54 is still disposed in the first section 271 and is in sealing contact with the section-defining wall 2710. As such, fluid communication between the first fluid passage 21 and the second fluid passage 23 can be closed by the second sealing element 55 before the first sealing element 54 is moved out of the first section 271 to allow the compressed air to enter into the rotor-driving chamber 26 when the first switch lever 51 is pressed to dispose the first valve unit 5 from the first state toward the second state, thereby preventing the possibility of simultaneous fluid communication between the first fluid passage 21 and the second fluid passage 23 and between the first fluid passage 21 and the rotor-driving chamber 26 from occurring.

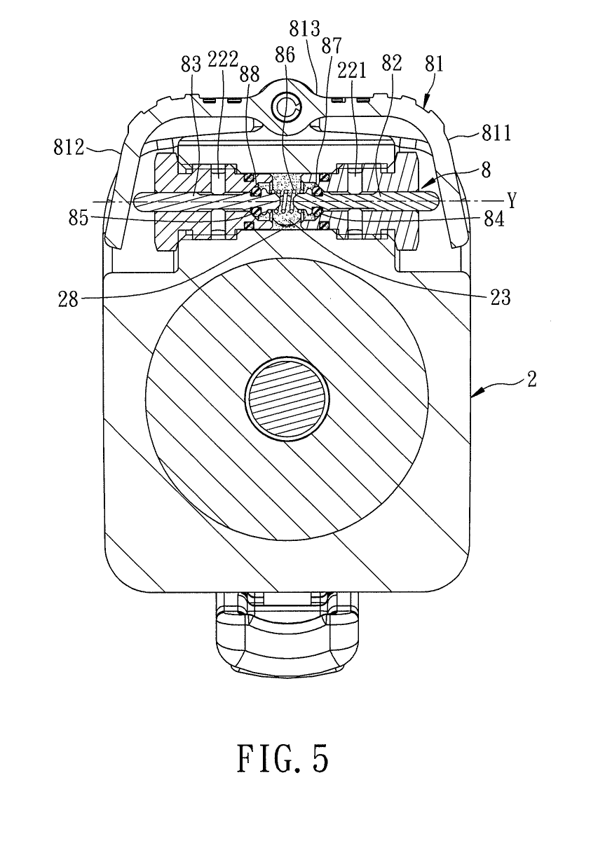

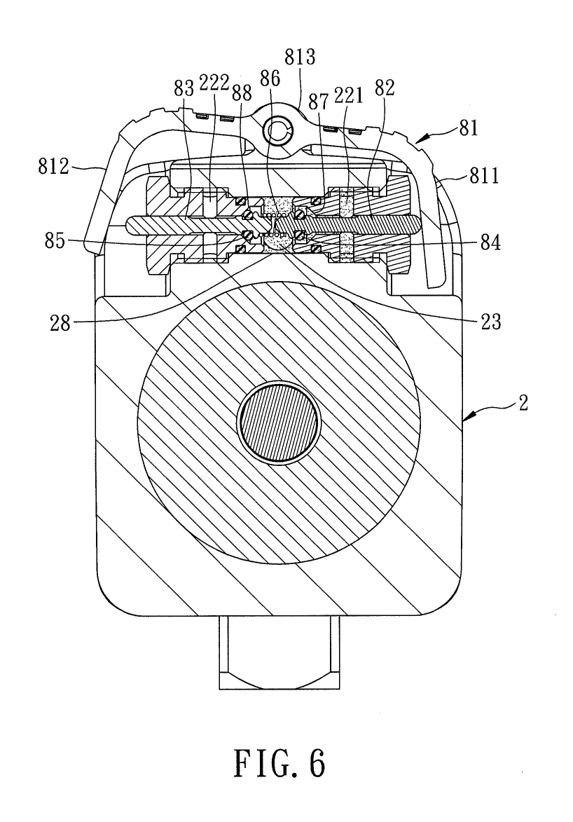

The second valve unit 8 is operatively mounted in the wrench housing 2 for controlling fluid communication between the second fluid passage 232 and a selected one of the third and fourth fluid passages 221, 222 so as to control switching of the rotational directions of the spindle 31, and is operable between a third state (not shown), that permits fluid communication between the second fluid passage 23 and the third fluid passage 221 while preventing fluid communication between the second fluid passage 23 and the fourth fluid passage 222, and a fourth state (see FIG. 6), that prevents fluid communication between the second fluid passage 23 and the third fluid passage 221 while permitting fluid communication between the second fluid passage 23 and the fourth fluid passage 222, thereby permitting switching of the rotational directions of the spindle 31. In addition, the second valve unit 8 is further operable at an intermediate state (see FIG. 5), in which the second fluid passage 23 is prevented from fluid communication with the third and fourth fluid passages 221, 222.

The second valve unit 8 defines first and second valve seats 87, 88 that are spaced apart from each other, and has first and second valve stems 82, 83 that are aligned with each other along a stem-moving direction (Y), first and second sealing elements 84, 85 that are mounted on the first and second valve stems 82, 83, respectively, and an urging member 86 that abuts against adjacent ends of the first and second valve stems 82, 83 so as to urge the first and second valve stems 82, 83 along the stem-moving direction (Y) in a manner to permit the first and second sealing elements 84, 85 to abut sealingly against the first and second valve seats 87, 88, respectively.

The first and second valve stems 82, 83 of the second valve unit 8 are disposed between and are aligned with the first and second pressing ends 811, 812 of the second switch lever 81 along the stem-moving direction (Y). The second switch lever 81 is rotatable relative to the wrench housing 2 for causing one of the first and second pressing ends 811, 812 to drive movement of a respective one of the first and second valve stems 82, 83 together with movement of a respective one of the first and second sealing elements 84, 85 away from a respective one of the first and second valve seats 87, 88 and for simultaneously moving the other of the first and second pressing ends 811, 812 away from the other of the first and second valve stems 82, 83, thereby permitting disposing of the second valve unit 8 between the third and fourth states. The first sealing element 84 is spaced apart from the first valve seat 87 while the second sealing element 85 is in sealing contact with the second valve seat 88 when the second valve unit 8 is disposed at the third state, thereby permitting fluid communication between the second fluid passage 23 and the third fluid passage 221 and preventing fluid communication between the second fluid passage 23 and the fourth fluid passage 222. The first sealing element 84 is in sealing contact with the first valve seat 87 while the second sealing element 85 is spaced apart from the second valve seat 88 when the second valve unit 8 is disposed at the fourth state, thereby preventing fluid communication between the second fluid passage 23 and the third fluid passage 221 and permitting fluid communication between the second fluid passage 23 and the fourth fluid passage 222.

With the inclusion of the first and second valve units 5, 8 in the pneumatic driven ratchet wrench of this invention, the aforesaid mis-switching drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A pneumatic driven ratchet wrench having a spindle and capable of preventing mis-switching of rotational directions of a spindle, said pneumatic driven ratchet wrench comprising:
a wrench housing having first and second sections and a middle section disposed between and interconnecting said first and second sections, said first section being formed with a first fluid passage, said middle section being formed with a second fluid passage, a rotor-driving chamber separated from said second fluid passage, and third and fourth fluid passages separated from said rotor-driving chamber;
a spindle-engaging unit mounted to said second section and including a ratchet wheel that is adapted to be associated with the spindle for switching rotational directions of the spindle;
a rotation-driving unit including a pneumatic rotor that is mounted rotatably in said rotor-driving chamber, that is adapted to be connected to said spindle, and that is adapted to be driven to rotate by a compressed air entering from said first fluid passage into said rotor-driving chamber so as to drive rotation of the spindle;
a direction-driving unit mounted in said wrench housing and adapted to be driven to move by the compressed air entering from said first fluid passage through said second fluid passage into a selected one of said third and fourth fluid passages;
a reverse gear unit mounted movably in said wrench housing and driven to move by said direction-driving unit to engage said ratchet wheel so as to switch rotational directions of the spindle;
a first valve unit operatively mounted in said wrench housing and operable to permit fluid communication between said first fluid passage and a selected one of said rotor-driving chamber and said second fluid passage while preventing fluid communication between said first fluid passage and the other of said rotor-driving chamber and said second fluid passage; and
a second valve unit operatively mounted in said wrench housing for controlling fluid communication between said second fluid passage and a selected one of said third and fourth fluid passages so as to control switching of the rotational directions of the spindle.

2. The pneumatic driven ratchet wrench of claim 1, wherein said first valve unit is operable between a first state, in which said first valve unit prevents fluid communication between said first fluid passage and said rotor-driving chamber while permitting fluid communication between said first fluid passage and said second fluid passage, and a second state, in which said first valve unit permits fluid communication between said first fluid passage and said rotor-driving chamber while preventing fluid communication between said first fluid passage and said second fluid passage, thereby rendering said pneumatic driven ratchet wrench capable of preventing mis-switching of the rotational directions of the spindle, said second valve unit being operable between a third state, in which said second valve unit permits fluid communication between said second fluid passage and said third fluid passage while preventing fluid communication between said second fluid passage and said fourth fluid passage, and a fourth state, in which said second valve unit prevents fluid communication between said second fluid passage and said third fluid passage while permitting fluid communication between said second fluid passage and said fourth fluid passage.

3. The pneumatic driven ratchet wrench of claim 2, wherein said middle section is further formed with first and second piston channels, each of said third and fourth fluid passages being disposed between said second fluid passage and a respective one of said first and second piston channels along a length direction of said middle section and being in fluid communication with the respective one of said first and second piston channels, said reverse gear unit including first and second reverse gears that are movably mounted in said wrench housing, said direction-driving unit including first and second pistons that are movably disposed in said first and second piston channels, respectively, and that are connected to said first and second reverse gears, respectively, each of said first and second pistons being driven to move by the compressed air entering from said first fluid passage through said second fluid passage into a respective one of said third and fourth fluid passages so as to drive movement of a respective one of said first and second reverse gears.

4. The pneumatic driven ratchet wrench of claim 1, further comprising a switch lever that is pivoted to an exterior of said wrench housing, said wrench housing being formed with a valve-receiving space that has first and second sections, said first section being defined by a section-defining wall and being in fluid communication with said rotor-driving chamber, said first valve unit having a valve body secured in said second section and having an inner wall surface, a valve stem, and first and second sealing elements that are mounted on said valve stem and that are spaced apart from each other, said inner wall surface defining a fluid channel that is in fluid communication with said second fluid passage, said switch lever being rotatable relative to said wrench housing to drive movement of said valve stem so as to permit disposing of said first valve unit between the first and second states, said first sealing element being disposed in said first section and being in sealing contact with said section-defining wall while said second sealing element is disposed outwardly of said fluid channel when said first valve unit is disposed at said first state, said first sealing element being disposed outwardly of said first section while said second sealing element is disposed in said fluid channel and being in sealing contact with said inner wall surface when said first valve unit is disposed at said second state.

5. The pneumatic driven ratchet wrench of claim 4, wherein said first valve unit further has an urging member for urging and restoring said valve stem and said switch lever to their original positions to dispose said first valve unit at the first state.

6. The pneumatic driven ratchet wrench of claim 2, further comprising a U-shaped switch lever that has first and second pressing ends and a middle pivot portion disposed between said first and second pressing ends and pivoted to an exterior of said wrench housing, said wrench housing being formed with a valve-receiving space that receives said second valve unit therein, said second valve unit defining first and second valve seats that are spaced apart from each other, and having first and second valve stems that are aligned with each other along a stem-moving direction, first and second sealing elements that are mounted on said first and second valve stems, respectively, and an urging member, said first and second valve stems being disposed between and aligned with said first and second pressing ends along the stem-moving direction, said urging member urging said first and second valve stems in a manner to permit said first and second sealing elements to abut sealingly against said first and second valve seats, respectively, said switch lever being rotatable relative to said wrench housing for causing one of said first and second pressing ends to drive movement of a respective one of said first and second valve stems together with movement of a respective one of said first and second sealing elements away from a respective one of said first and second valve seats and for simultaneously moving the other of said first and second pressing ends away from the other of said first and second valve stems, thereby permitting disposing of said second valve unit between the third and fourth states, said first sealing element being spaced apart from said first valve seat while said second sealing element is in sealing contact with said second valve seat when said second valve unit is disposed at the third state, said first sealing element being in sealing contact with said first valve seat while said second sealing element is spaced apart from said second valve seat when said second valve unit is disposed at the fourth state.

7. The pneumatic driven ratchet wrench of claim 2, wherein said first valve unit is further operable at a middle state between said first and second states, in which said first valve unit prevents fluid communication between said first fluid passage and said rotor-driving chamber and between said first fluid passage and said second fluid passage.
